(19) United States
(12) Patent Application Publication
(10) Pub. No.: US 2024/0087390 A1
(43) Pub. Date: Mar. 14, 2024

(54) SYSTEM AND METHOD FOR GROUP CONSENSUS VOTING FOR GAMES AND SHOWS

(71) Applicant: BELADED INC, Houston, TX (US)

(72) Inventors: Fortune Vieyra, Miami Beach, FL (US); Gilbert Hippolyte, Miami Beach, FL (US)

(21) Appl. No.: 18/134,534

(22) Filed: Apr. 13, 2023

Related U.S. Application Data
(60) Provisional application No. 63/330,627, filed on Apr. 13, 2022.

(51) Int. Cl. G07C 13/00

(52) U.S. Cl. CPC G07C 13/00

(57) ABSTRACT

A system and method for a threshold-based and/or timer-based voting session are described. This includes users rapidly clicking on votes or entering a bulk vote quantity, the higher votes during a given timeframe (5 seconds), the higher the threshold, the less votes during a given timeframe (5 seconds), the lower the threshold. Thresholds can be a bar chart (rising and falling), an odometer (rotating left to right) or the like, and may be gradual. This includes starting the timer with for a given length of time (i.e., 60 seconds). Users may click on votes (one vote at a time) or enter a bulk vote quantity (i.e., 25 votes total, or the like). When the timer reaches zero seconds (or a value if counting up), the host performs the voted action. The host may have a given time (e.g., 10 seconds) to perform the action.

### CROSS REFERENCE TO RELATED APPLICATIONS

This application claims the benefit of U.S. Provisional Application No. 63/330,627, filed Apr. 13, 2022, which is incorporated by reference as if fully set forth.

### FIELD OF INVENTION

The present invention is directed to online interactions with games and shows. More particularly, the present invention is directed to a system and method for group consensus voting for games and shows.

### BACKGROUND

Currently, there is no quality way for people who play games and/or watch shows to be able to participate as a group or as individuals through votes. For example, a television-based show where audiences get to vote on performances, such as dance performances, singing performances or other acts, for example. The currently available functionality does not support game play or changes to a show in real time. For example, currently, votes are performed at the end of show. That is, voting session are usually performed after or before gameplay, not during the gameplay. Votes for casting results of a game may occur before the game begins. Votes casted after the game play may be performed for polling purposes. This include which all-star player performed the best.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is a block diagram of an example device in which one or more features of the disclosure can be implemented;

FIG. 2 is a block diagram of an example system for remotely interacting with other devices within the system of the present invention;

FIG. 3 is a system diagram of an example of a computing environment in communication with network according to one or more embodiments;

FIG. 4 illustrates a system for performing the activities of the present invention;

FIG. 5 illustrates a graphical depiction of the communication between an entity, such as a user, for example, and a host that may occur within the present system to achieve the methods described;

FIG. 6 illustrates a graphical depiction to illustrate the framework of the token configured to enable the system to utilizes tokens between an entity and a host;

FIG. 7 illustrates a graphical depiction of a token-based communication between an entity and a host in the system;

FIG. 8 illustrates a graphical depiction of a token-based announcement(s) where an entity 81 requests an available host to conduct an announcement;

FIG. 9 illustrates a graphical depiction of a token-based announcement(s) where an entity requests a host to conduct an announcement;

FIG. 10 illustrates a graphical depiction of a token-based voting where an entity provides a vote;

FIG. 11 illustrates a graphical depiction of a method or flow illustrating live event voting at a live event;

FIG. 12 illustrates a graphical depiction of a method or flow enabling team votes in a virtual example related to basketball games;

FIG. 13 illustrates a graphical depiction of a method or flow enabling team votes in a virtual example related to soccer games;

FIG. 14 illustrates a depiction of a method or flow in a system where groups of users vote, such as when users are in an audience watching a comedy show;

FIG. 15 illustrates a depiction of a method or flow of a system where groups of users vote on threshold votes; and

FIG. 16 illustrates a depiction of a method or flow of the system where groups vote on threshold votes.

### DETAILED DESCRIPTION

The present system and method includes the ability to perform time-based votes where votes affect the game or show in real time. Votes can be casted individually or in groups, as a unit or fractional, and can be measured by any unit of value/measurement. currency/values/demand/time. Since it's also consensus based, groups can vote to perform an action on a game or show or during a game or show in real time; real time interactions can be performed via live streaming which includes broadcasting and recording video simultaneously; consensus-based votes can be performed at an event such as a live event, and also virtually.

For example, a physical vote may include groups of people at a concert with a voting apparatus that contain controls for voting for a particular artist during a show. In another example, American Idol, audiences vote for their favorite contestants. The performers perform first then audiences vote after they are done and even after the season is over. In Fan duel, users cast a vote in a form of a bet before the games begins. Votes are placed for groups/teams and individual players.

The present system and method make use of predetermination on post determination in our voting. Audiences are able to alter the results of a game in real life by predetermining the actions of the game/show through votes, i.e., real time vote. Audiences are able to vote on what they think will happen. —forecasting/predicting. Virtual votes of a group of people voting through a mobile application or website in real time place time-based votes—include any amount of time between votes and action performed based on votes. Users can participate in a 1 min vote where the results of the vote are up when the minute expires. The highest vote determines the action of the game or show in real time. In one example, a game left square or right square, where a collection of users go left, collection of users go right within a min time frame. After a minute, the highest vote enables actions to be performed by an avatar by moving left or right. The consensus-based vote allows the game or show to make the use of live and/or virtual avatars. As is understood, an avatar is a person with a physical or digital representing the entity that is considered a player in the game/performer. The actual game players are a collection of users who vote.

The present system and method provides a way for people who play games and watch shows to be able to vote in real time in a way that affects the game or show.

Within the framework of the provided description, consensus-based entertainment systems and methods may be employed. This may include time-based votes that determine the next move in a game or show.

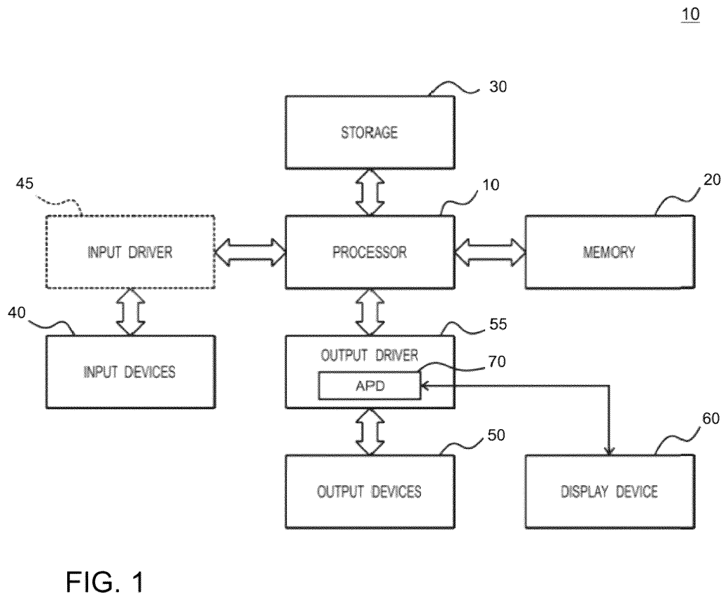

FIG. 1 is a block diagram of an example, device 1 in which one or more features of the disclosure can be implemented. The device 1 can include, for example, a computer, a gaming device, a handheld device, a set-top box, a television, a mobile phone, server, a tablet computer or other types of computing devices. The device 1 includes a processor 10, a memory 20, a storage 30, one or more input devices 40, and one or more output devices 50. The device 1 can also optionally include an input driver 45 and an output driver 55. It is understood that the device 1 can include additional components not shown in FIG. 1.

In various alternatives, the processor 10 includes a central processing unit (CPU), a graphics processing unit (GPU), a CPU and GPU located on the same die, or one or more processor cores, wherein each processor core can be a CPU or a GPU. In various alternatives, the memory 20 is located on the same die as the processor 10, or is located separately from the processor 10. The memory 20 includes a volatile or non-volatile memory, for example, random access memory (RAM), dynamic RAM, or a cache.

The storage 30 includes a fixed or removable storage, for example, a hard disk drive, a solid-state drive, an optical disk, or a flash drive. The input devices 40 include, without limitation, a keyboard, a keypad, a touch screen, a touch pad, a detector, a microphone, an accelerometer, a gyroscope, a biometric scanner, or a network connection (e.g., a wireless local area network card for transmission and/or reception of wireless IEEE 802 signals). The output devices 50 include, without limitation, a display device 60, a display connector/interface (e.g., an HDMI or DisplayPort connector or interface for connecting to an HDMI or Display Port compliant device), a speaker, a printer, a haptic feedback device, one or more lights, an antenna, or a network connection (e.g., a wireless local area network card for transmission and/or reception of wireless IEEE 802 signals).

The input driver 45 communicates with the processor 10 and the input devices 40, and permits the processor 10 to receive input from the input devices 40. The output driver 55 communicates with the processor 10 and the output devices 50, and permits the processor 10 to send output to the output devices 50. It is noted that the input driver 45 and the output driver 55 are optional components, and that the device 1 may operate in the same manner if the input driver 45 and the output driver 55 are not present. The output driver 55 may include an accelerated processing device (“APD”) 70 which is coupled to a display device 60. The APD accepts compute commands and graphics rendering commands from processor 10, processes those compute and graphics rendering commands, and provides pixel output to display device 60 for display. As described in further detail below, the APD 70 includes one or more parallel processing units to perform computations in accordance with a single-instruction-multiple-data (“SIMD”) paradigm. Thus, although various functionality is described herein as being performed by or in conjunction with the APD 70, in various alternatives, the functionality described as being performed by the APD 70 is additionally or alternatively performed by other computing devices having similar capabilities that are not driven by a host processor (e.g., processor 10) and provides graphical output to a display device 60. For example, it is contemplated that any processing system that performs processing tasks in accordance with a SIMD paradigm may perform the functionality described herein. Alternatively, it is contemplated that computing systems that do not perform processing tasks in accordance with a SIMD paradigm can also perform the functionality described herein.

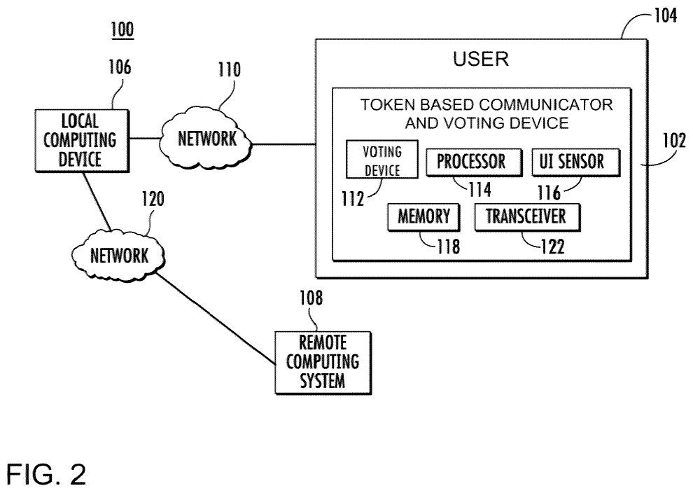

FIG. 2 is a block diagram of an example system for remotely interacting with other devices within the system of the present invention. In the example illustrated in FIG. 2, the system 100 includes a token-based communicator and voting device 102 associated with a user 104, a local computing device 106, a remote computing system 108, a first network 110, a voting device 112, a processor 114, a user input (UI) sensor 116, a memory 118, a second network 120, and a transmitter-receiver (i.e., transceiver) 122.

According to an embodiment, the token-based communicator and voting device 102 may be an apparatus that useable by a user to provide input and feedback related to a display that is configured on the token-based communicator and voting device 102 or external to the token-based communicator and voting device 102, such as the device 10 of FIG. 1. The token-based communicator and voting device 102 may be handheld by a user and may include feedback devices and sensors configured to allow the user to provide feedback, such as by voting, for example. Additionally, the token-based communicator and voting device 102 may be configured to include devices that allow the user to watch video, live streams, for example. The token-based communicator and voting device 102 may include a display.

According to an embodiment, the token-based communicator and voting device 102 may be an apparatus that is external to the viewing device, such as a separate computing device from the display. For example, as described in more detail below, the token-based communicator and voting device 102 may include an phone, or computing device. The token-based communicator and voting device 102 may also include a display, an interactive screen, or the like, capable of receiving user input.

According to an embodiment, the token-based communicator and voting device 102 may include both components that are internal to the user display of the video and components that are external to the user display of the video.

The single token-based communicator and voting device 102 is shown in FIG. 2. Example systems may, however, may include a plurality of token-based communicator and voting apparatuses. A token-based communicator and voting apparatus may be in communication with one or more other token-based communicator and voting apparatuses. Additionally or alternatively, token-based communicator and voting apparatus may be in communication with the network 110.

One or more token-based communicator and voting apparatuses 102 may acquire user input (e.g., voting, token purchase, token spend, notification, communication from others users, communication from hosts, and recommendations) and receive at least a portion of video and communications representing the live stream or video associated with a user selection from one or more other token-based communicator and voting apparatuses 102. The additional information may be, for example, voting, token purchase, token spend, notification, communication from others users, communication from hosts, and recommendations. Each of the token-based communicator and voting device 102 may process data, including its own acquired voting, token purchase, token spend, notification, communication from others users, communication from hosts, and recommendations as well as voting, token purchase, token spend, notification, communication from others users, communication from hosts, and recommendations received from one or more other token-based communicator and voting apparatuses 102.

In FIG. 2, the network 110 is an example of a short-range network (e.g., local area network (LAN), or personal area network (PAN)). Information may be sent, via the network 110, between the token-based communicator and voting device 102 and the local computing device 106 using any one of various short-range wireless communication protocols, such as Bluetooth, Wi-Fi, Zigbee, Z-Wave, near field communications (NFC), ultraband, Zigbee, or infrared (IR).

The network 120 may be a wired network, a wireless network or include one or more wired and wireless networks. For example, the network 120 may be a long-range network (e.g., wide area network (WAN), the internet, or a cellular network). Information may be sent, via the network 120 using any one of various long-range wireless communication protocols (e.g., TCP/IP, HTTP, 3G, 4G/LTE, or 5G/New Radio).

The token-based communicator and voting device 102 may include the voting device 112, the processor 114, the UI sensor 116, the memory 118, and the transceiver 122. The token-based communicator and voting device 102 may continually or periodically monitor, store, process and communicate, via the network 110, any number of various electronic media and communication methods. Examples of electronic media include videos, video shorts, TikTok, reels, YouTube, Instagram, Facebook, music, phone ring tones, screen savers, text messages and alerts, vibration mechanisms, lighting probes and alerts, and the like. Examples of communications messages include live chat, SMS messages, audio and/or video phone calls, and the like, that may be monitored into to provide interaction with the systems of the present invention.

The voting device 112 may include, for example, one or more sensors configured to sense a type of input from a user. For example, the voting device 112 may include an electrode configured to acquire electrical signals or a temperature sensor, that provide input into the video viewing system. As described in more detail below, the token-based communicator and voting device 102 may be a voting tracker and may provide accounting for token management. The voting device 112 may include one or more inputs for acquiring user inputs in voting. The voting signals (votes) may be used to provide hosts information certain tasks to perform.

In another example, the token-based communicator and voting device 102 may be a a wearable device. The wearable device may monitor signals from the user based on the reaction to video being viewed on a screen display and this data may be sent to a host for action without user intervention.

The transceiver 122 may include a separate transmitter and receiver. Alternatively, the transceiver 122 may include a transmitter and receiver integrated into a single device.

The processor 114 may be configured to store user interactions, such as voting in the memory 118 acquired by the voting device 112, and communicate the videos and other feedback, across the network 110, via a transmitter of the transceiver 122. Data from one or more other token-based communicator and voting device 102 may also be received by a receiver of the transceiver 122, as described in more detail below.

According to an embodiment, the token-based communicator and voting device 102 includes UI sensor 116 which may be, for example, a piezoelectric sensor or a capacitive sensor configured to receive a user input, such as a tapping or touching. For example, the UI sensor 116 may be controlled to implement a capacitive coupling, in response to tapping or touching a surface of the token-based communicator and voting device 102 by the user 104. Gesture recognition may be implemented via any one of various capacitive types, such as resistive capacitive, surface capacitive, projected capacitive, surface acoustic wave, piezoelectric and infra-red touching. Capacitive sensors may be disposed at a small area or over a length of the surface such that the tapping or touching of the surface activates the monitoring device.

As described in more detail below, the processor 114 may be configured to respond selectively to different tapping patterns of the capacitive sensor (e.g., a single tap or a double tap), which may be the UI sensor 116, such that different tasks of the patch (e.g., acquisition, storing, or transmission of data) may be activated based on the detected pattern. In some embodiments, audible feedback may be given to the user from the token-based communicator and voting device 102 when a gesture is detected.

The local computing device 106 of the system 100 is in communication with the token-based communicator and voting device 102 and may be configured to act as a gateway to the remote computing system 108 through the second network 120. The local computing device 106 may be, for example, a, smart phone, smartwatch, tablet or other portable smart device configured to communicate with other devices via the network 120. Alternatively, the local computing device 106 may be a stationary or standalone device, such as a stationary base station including, for example, modem and/or router capability, a desktop or laptop computer using an executable program to communicate information between the token-based communicator and voting device 102 and the remote computing system 108 via the PC's radio module, or a USB dongle. Voting, announcements, payments and video streams may be communicated between the local computing device 106 and the token-based communicator and voting device 102 using a short-range wireless technology standard (e.g., Bluetooth, Wi-Fi, ZigBee, Z-wave and other short-range wireless standards) via the short-range wireless network 110, such as a local area network (LAN) (e.g., a personal area network (PAN)). In some embodiments, the local computing device 106 may also be configured to display video, live streams, recorded live streams, a token bank, a voting questions, as described in more detail below.

In some embodiments, the remote computing system 108 may be configured to receive at least one of the votes, videos, tokens, and text associated with the users via network 120, which is a long-range network. For example, if the local computing device 106 is a mobile phone, network 120 may be a wireless cellular network, and information may be communicated between the local computing device 106 and the remote computing system 108 via a wireless technology standard, such as any of the wireless technologies mentioned above. As described in more detail below, the remote computing system 108 may be configured to provide (e.g., visually display and/or aurally provide) at least one of the votes, videos, tokens, and text to a host.

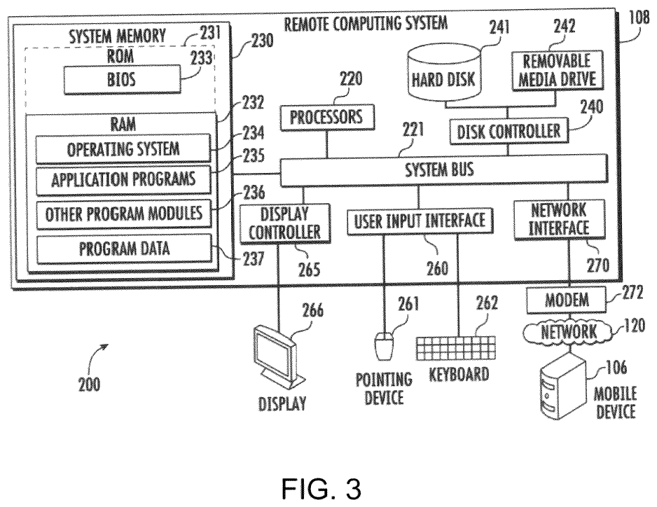

FIG. 3 is a system diagram of an example of a computing environment 200 in communication with network 120. In some instances, the computing environment 200 is incorporated in a public cloud computing platform (such as Amazon Web Services or Microsoft Azure), a hybrid cloud computing platform (such as HP Enterprise OneSphere) or a private cloud computing platform.

As shown in FIG. 3, computing environment 200 includes remote computing system 108 (hereinafter computer system), which is one example of a computing system upon which embodiments described herein may be implemented.

The remote computing system 108 may, via processors 220, which may include one or more processors, perform various functions. The functions may include providing video streams, analyzing and tabulating votes from users, receiving communications from users, providing output from a host and the associated information and, monitoring token related activities and parameters, providing (e.g., via display 266) alerts, additional information or instructions. As described in more detail below, the remote computing system 108 may be used to provide (e.g., via display 266) users and hosts with a videos and streams of activities and sporting events, such that such information may enable interaction with the videos, hosts and other users to add to the enjoyment of viewing.

As shown in FIG. 3, the computer system 210 may include a communication mechanism such as a bus 221 or other communication mechanism for communicating information within the computer system 210. The computer system 210 further includes one or more processors 220 coupled with the bus 221 for processing the information. The processors 220 may include one or more CPUs, GPUs, or any other processor known in the art.

The computer system 210 also includes a system memory 230 coupled to the bus 221 for storing information and instructions to be executed by processors 220. The system memory 230 may include computer readable storage media in the form of volatile and/or nonvolatile memory, such as read only system memory (ROM) 231 and/or random-access memory (RAM) 232. The system memory RAM 232 may include other dynamic storage device(s) (e.g., dynamic RAM, static RAM, and synchronous DRAM). The system memory ROM 231 may include other static storage device(s) (e.g., programmable ROM, erasable PROM, and electrically erasable PROM). In addition, the system memory 230 may be used for storing temporary variables or other intermediate information during the execution of instructions by the processors 220. A basic input/output system 233 (BIOS) may contain routines to transfer information between elements within computer system 210, such as during start-up, that may be stored in system memory ROM 231. RAM 232 may comprise data and/or program modules that are immediately accessible to and/or presently being operated on by the processors 220. System memory 230 may additionally include, for example, operating system 234, application programs 235, other program modules 236 and program data 237.

The illustrated computer system 210 also includes a disk controller 240 coupled to the bus 221 to control one or more storage devices for storing information and instructions, such as a magnetic hard disk 241 and a removable media drive 242 (e.g., floppy disk drive, compact disc drive, tape drive, and/or solid-state drive). The storage devices may be added to the computer system 210 using an appropriate device interface (e.g., a small computer system interface (SCSI), integrated device electronics (IDE), Universal Serial Bus (USB), or FireWire).

The computer system 210 may also include a display controller 265 coupled to the bus 221 to control a monitor or display 266, such as a cathode ray tube (CRT) or liquid crystal display (LCD), for displaying information to a computer user. The illustrated computer system 210 includes a user input interface 260 and one or more input devices, such as a keyboard 262 and a pointing device 261, for interacting with a computer user and providing information to the processor 220. The pointing device 261, for example, may be a mouse, a trackball, or a pointing stick for communicating direction information and command selections to the processor 220 and for controlling cursor movement on the display 266. The display 266 may provide a touch screen interface that may allow input to supplement or replace the communication of direction information and command selections by the pointing device 261 and/or keyboard 262.

The computer system 210 may perform a portion or each of the functions and methods described herein in response to the processors 220 executing one or more sequences of one or more instructions contained in a memory, such as the system memory 230. Such instructions may be read into the system memory 230 from another computer readable medium, such as a hard disk 241 or a removable media drive 242. The hard disk 241 may contain one or more data stores and data files used by embodiments described herein. Data store contents and data files may be encrypted to improve security. The processors 220 may also be employed in a multi-processing arrangement to execute the one or more sequences of instructions contained in system memory 230. In alternative embodiments, hard-wired circuitry may be used in place of or in combination with software instructions. Thus, embodiments are not limited to any specific combination of hardware circuitry and software.

As stated above, the computer system 210 may include at least one computer readable medium or memory for holding instructions programmed according to embodiments described herein and for containing data structures, tables, records, or other data described herein. The term computer readable medium as used herein refers to any non-transitory, tangible medium that participates in providing instructions to the processor 220 for execution. A computer readable medium may take many forms including, but not limited to, non-volatile media, volatile media, and transmission media. Non-limiting examples of non-volatile media include optical disks, solid state drives, magnetic disks, and magneto-optical disks, such as hard disk 241 or removable media drive 242. Non-limiting examples of volatile media include dynamic memory, such as system memory 230. Non-limiting examples of transmission media include coaxial cables, copper wire, and fiber optics, including the wires that make up the bus 221. Transmission media may also take the form of acoustic or light waves, such as those generated during radio wave and infrared data communications.

The computing environment 200 may further include the computer system 210 operating in a networked environment using logical connections to local computing device 106 and one or more other devices, such as a personal computer (laptop or desktop), mobile devices (e.g., patient mobile devices), a server, a router, a network PC, a peer device or other common network node, and typically includes many or all of the elements described above relative to computer system 210. When used in a networking environment, computer system 210 may include modem 272 for establishing communications over a network 120, such as the Internet. Modem 272 may be connected to system bus 221 via network interface 270, or via another appropriate mechanism.

Network 120, as shown in FIGS. 2 and 3, may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 610 and other computers (e.g., local computing device 106).

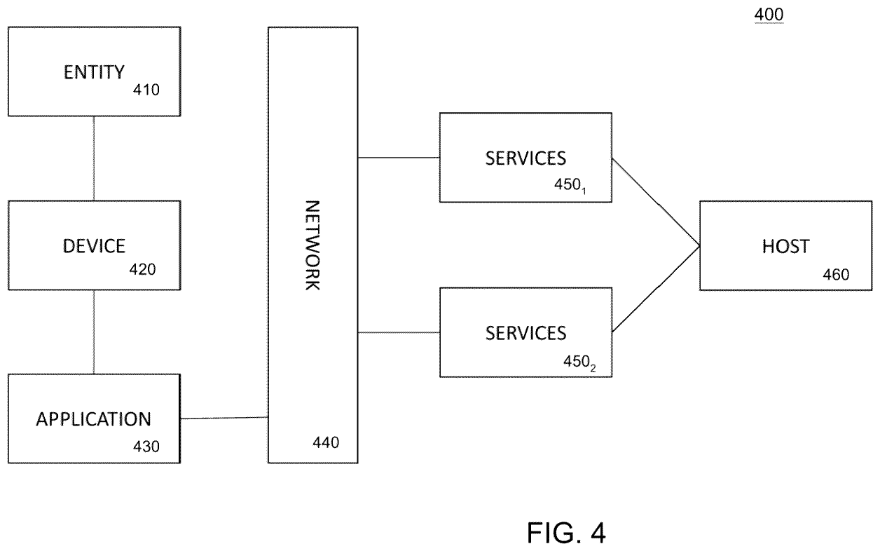

FIG. 4 illustrates a system 400 for performing the activities of the present invention. FIG. 4 illustrates an entity 410, which may take the form of a user, host, team, person and/or artificial intelligence bot, for example, using a device 420, such as a phone, computer, smart watch, web camera, virtual reality glasses, television, games console, headphones and or other applicable device, for example, to access and application 430, such as a browser, website, application and/or livestream, for example. This access may occur over a network 440 via servers (not shown), cloud network, database, WI FI and/or router with networks including cellular networks, satellite networks, wide area networks, cloud network, local area network, as would be understood. The entity 410, also referred to as a user, performs services 4501, such as voting via clicks or other interactions, notifications, payments and tips, for example. The information associated with services 4501 may be provided to a host 460. The entity 410 access services 4502, such as announcements, messages, priority messages, live chats and video calls, for example, to interact with the host 460.

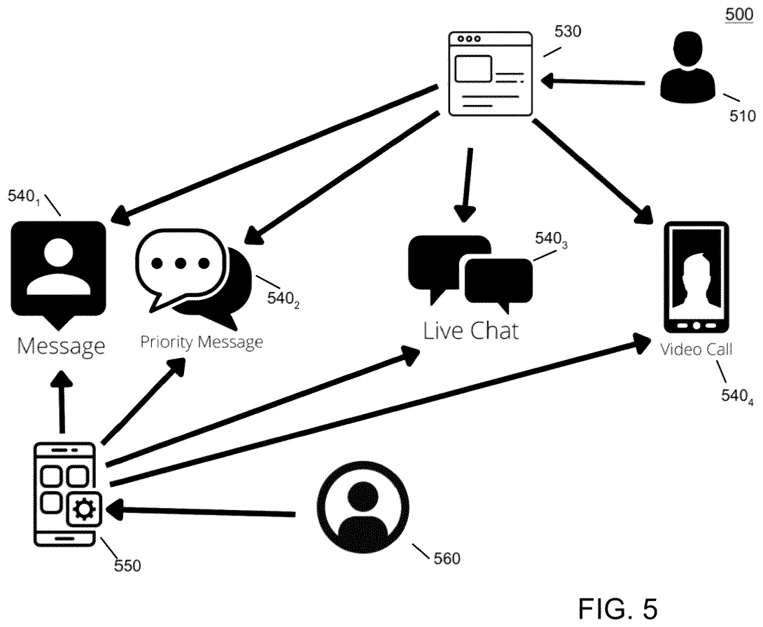

FIG. 5 illustrates a graphical depiction 500 of the communication between an entity 510, such as a user, for example, and a host 560 that may occur within the present system to achieve the methods described. Entity 510 may use an application 530 that connects via the network as described above. Entity 510 may utilize application 530 to access via one or more messages 5401, one or more priority messages 5402, one or more live chats 5403 and/or one or more video calls 5404 to communicate with host 560 via one or more applications 550.

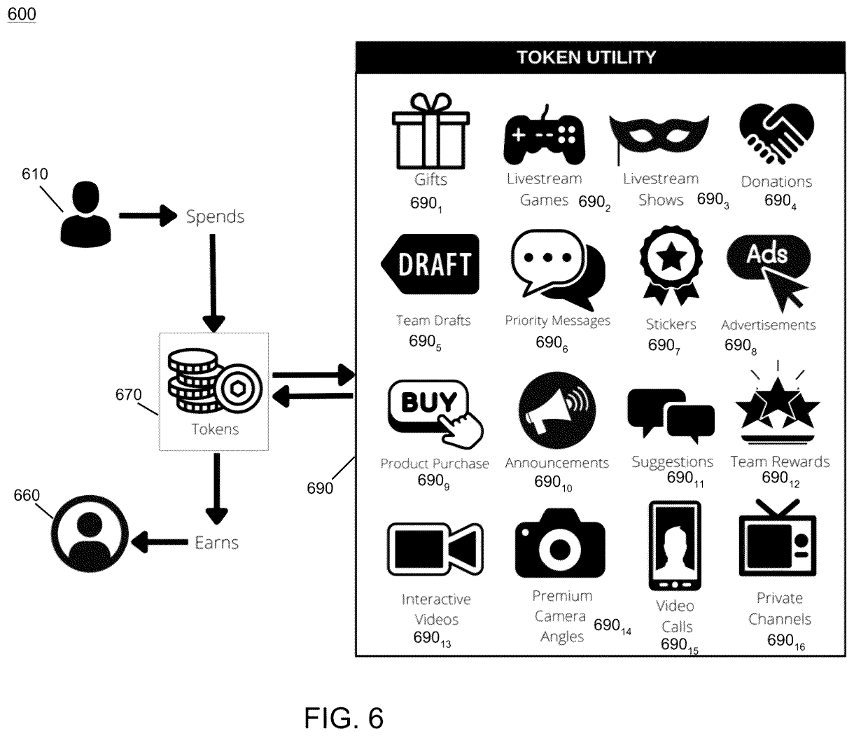

FIG. 6 illustrates a graphical depiction 600 to illustrate the framework of the token 670 configured to enable the system to utilizes tokens 670 between an entity 610 and a host 660. Entity 610 may acquire tokens 670 and may spend the acquired tokens 670 during interactions with the system. Entity 610 may acquire tokens by purchasing, performing activities within the system, such as by acting as a host or other entity in a different aspect of the system, for example, and/or may be given tokens by other entities within the system. Once acquired, tokens 670 may be used to acquire services within the present system. The acquired tokens 670 may be held and accounted for within the system.

When the entity exchanges the acquired tokens 670 for services with the system, in an aspect of the embodiment, tokens 670 may be held in a repository (not shown) until/while host 660 earns an allocated set of tokens 670 by performing the purchased activity. For example, if 10 tokens 670 are used to purchase an activity where the host 660 juggles without fail for 1 minutes. Those 10 tokens may be held in the repository until the activity is completed. Tokens 670 involved in the transaction may be removed from the account of entity 610 and transferred to host 660. There may be a period where the transacted tokens 670 are held in between accounts while host 660 performs the agreed activity.

In some embodiments, the activity may be one or more voting activities 690. One or more voting activities 690 may include, by way of example, one or more tips 690₁, one or more games 690₂, one or more priority messages 690₃, one or more team drafts 690₄, one or more shows 690₅, one or more live chats 690₆, one or more product producers 690₇, one or more premium camera angles 690₈, one or more video calls 690₉, one or more interactive videos 690₁₀, one or more announcements 690₁₁ and/or one or more stickers 690₁₂.

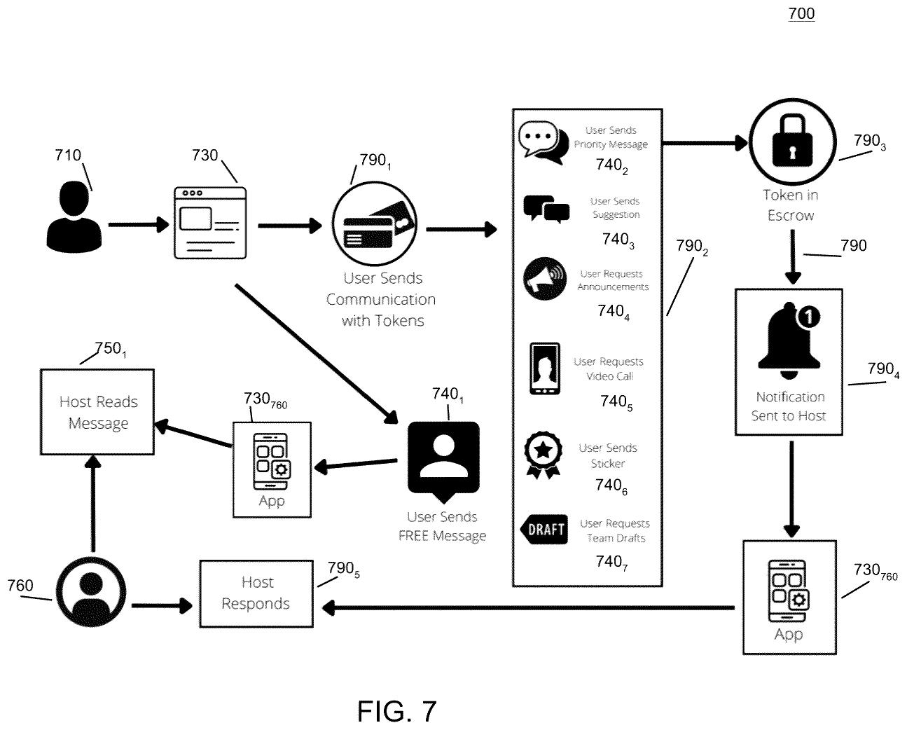

FIG. 7 illustrates a graphical depiction 700 of a token-based communication between an entity 710 and a host 760 in the system. As described above, the token-based communication may include one or more messages 740₁, 740₂, one or more chats 740₃ and/or one or more calls 740₄. The handling 750, 790 of the communication is explained further below.

In an example, the present system may include free messages, such as for example in FIG. 7 one or more messages 740₁. The free side handling 750 may include entity 710 accessing an application 730 to send one or more free messages 740₁. Host 760 may utilize a version of the application 730₇₆₀ to access the message, such as by reading the message 750₁. Host 760, although not specifically illustrated, may respond with one or more response messages, or may respond by converting the communication to one handled on the pay side handling 790.

On the pay side handling 790, entity 710 accesses the application 730 (which may be the same application or may be a different application) to send a communication 790₂, such as one or more messages 740₂, one or more chat requests 740₃, or one or more call requests 740₄ along with the tokens associated with the fee for the sent send one or more messages 740₂, one or more chat requests 740₃, or one or more call requests 740₄. The tokens associated with the fee may be held in escrow 790₃. A notification 790₄ is sent to the host, such as sent through the application 730₇₆₀ of the host 760. The host 760 may then respond 7905.

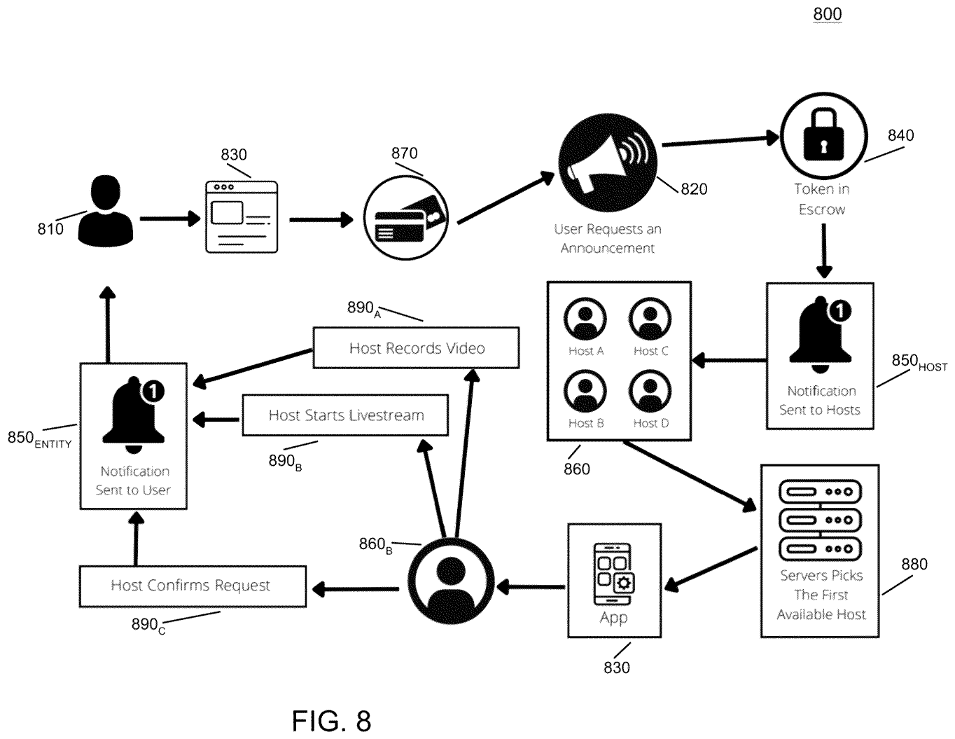

FIG. 8 illustrates a graphical depiction 800 of a token-based announcement(s) where an entity 810 requests an available host 860_{B} to conduct an announcement. Such an announcement may occur during livestream or recorded videos, for example. The token-based announcement is handled, as depicted in depiction 800, entity 810 accesses the application 830 (which may be the same application or may be a different application) to acquire tokens 870 to use to request an announcement 820. The tokens associated with the announcement may be held in escrow 840 while the performance of the announcement occurs. Once the request 820 is made, and the tokens are held in escrow 840, the host 860 is notified 850_{HOST}. A selection of the host 860 is made, such as based on availability, and the system may make the selection 880, from an available set of hosts, such as hosts A, host B, host C, host D (collectively hosts 860). A notification 880 is sent to the selected host, in the example host B 860_{B}. The notification 880 may be sent through the application 830 of the host B 860_{B}. The host B 860_{B} may then respond 890. For example, the notification 880 is sent to the host 860, with the server selecting 880 the first available host B 860_{B}. The host B 860_{B} records a video 890_{A} or stars in the live stream 890B, while confirming the user requests at 890_{C}. The system notifies at 850_{ENTITY} the entity of the video recordation at 890_{A}, livestream 890B, and the confirmation at 890_{C}.

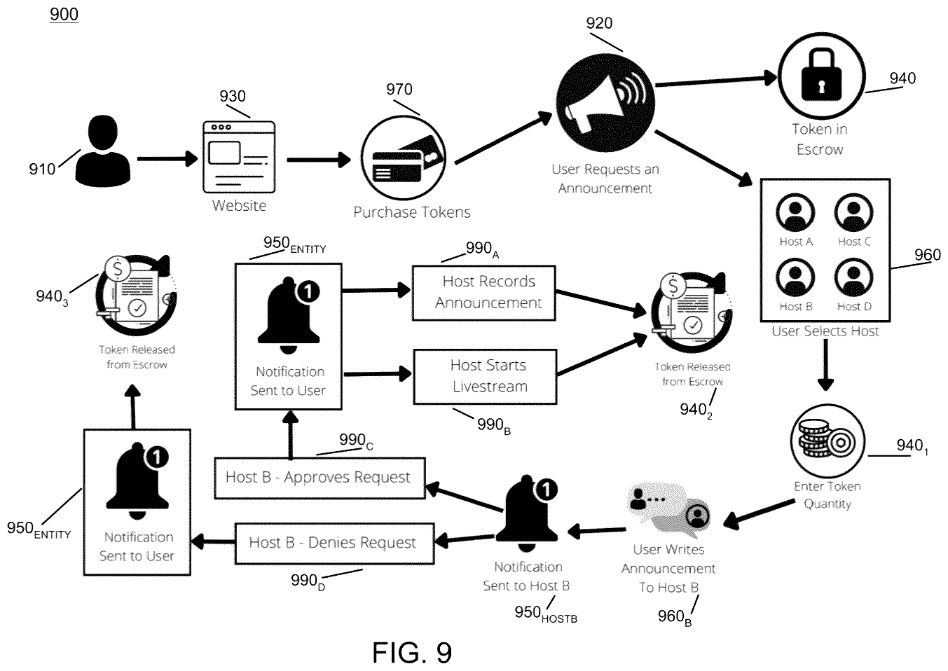

FIG. 9 illustrates a graphical depiction 900 of a token-based announcement(s) where an entity 910 requests an available host 860_{B} to conduct an announcement. Such an announcement may occur during livestream or recorded videos, for example. The token-based announcement is handled, as depicted in depiction 900, entity 910 accesses the application 930 (which may be the same application or may be a different application) to acquire tokens 970 to use to request an announcement 920. The tokens associated with the announcement may be held in escrow 940 while the performance of the announcement occurs. Once the request 920 is made, and in parallel with the tokens being held in escrow 940, the host 960 is contacted and a token quantity 940₁ is provided for recording the announcement by the host 960. Entity 910 provides the announcement at 960_{B} and the host 960 is notified 950_{HOST}. A selection of the host 960 is made, such as based on availability, and the entity 910 may make the selection from an available set of hosts, such as hosts A, host B, host C, host D (collectively hosts 960). The user selects and requests a specific host to conduct the announcement during livestream or recorded videos. If the selected host 960 denies the request at 990_{D} notification 950_{ENTITY} is provided to the entity 910 and the tokens are refunded at 940₃. The host 860 may approve the request 990C and notification 950_{ENTITY} is send to entity 910. After notifying the entity 910, the host 960 may record announcement 990_{A} and starts the livestream 990_{B} based on the agreed upon activities. The host records a video or stars in the live stream, confirms user requests and send notification to the users. Once completed the tokens may be released 940₂.

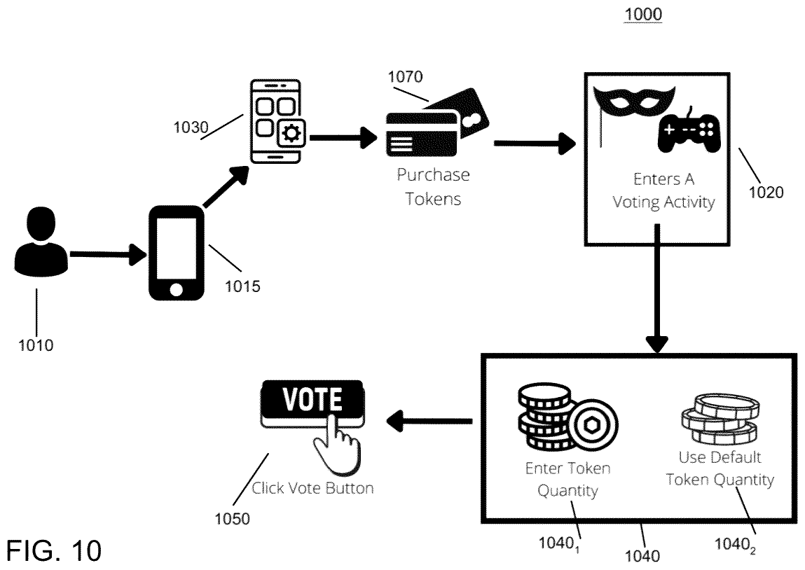

FIG. 10 illustrates a graphical depiction 1000 of a token-based voting where an entity 1010 provides a vote 1050. The voting uses tokens and is explained in an activity agnostic configuration. An entity 1010 uses a device 105 to access the application 1030 (which may be the same application or may be a different application) to acquire tokens 1070 to use to vote 1050. Entity 1010 enters voting activity 1020 and provides tokens 1040 to place a vote 1050. Providing tokens 1040 may include one or more of entering a token quantity 1040₁ and using a default token quantity 1040₂. Once the tokens are provided 1040 a vote 105 may be cast by entity 1010.

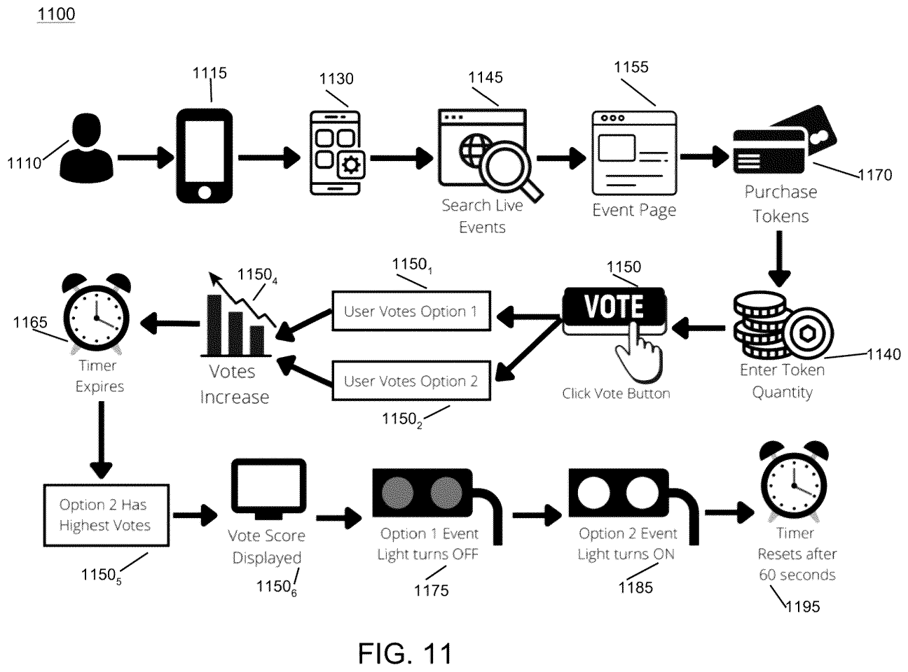

FIG. 11 illustrates a graphical depiction 1100 of a method or flow illustrating live event voting at a live event. Such live events may include sporting games, concerts, shows and events. The live event voting is handled, as depicted in depiction 1100, entity 1110 accesses the application 1130 (which may be the same application or may be a different application) via a device 1115 to acquire tokens 1170 to use to live event vote. Entity 1110 may search live events 1145 to find one that is desired and may access a selected live event web page 1155. Tokens may be purchased 1170, and a token quantity entered 1140 for the voting 1150. The voting 1150 across the various voting entities is tabulated 1150₄ (for example, one entity votes option 1 1150₁ and second entity votes option 2 1150₂) until a timer expires 1165. Once the timer expires 1165, the option with the most votes 1150₅ is determined and the vote score is displayed 1150₆. The activity 1175, 1185 receiving the most votes occurs. A timer then resets 1195 after some period of time, and the process is repeated.

Actions can be triggered by counting votes 1150₄ until the expiration of a timer 1165. Alternatively, or additionally, a threshold number of votes may be used to close the vote leading to an action. In a combined scenario, both a timer and a threshold may be set, with the action occurring when the first of the timer expiring or threshold being met is reached. The vote may be ceased, when the timer expires or a threshold number is votes are placed or reached for an outcome.

After a threshold, or expiration of time, the voted action 1175, 1185 may be performed. For example, the host (not shown) receives a notification on website (laptop, mobile phone, Bluetooth, monitor, or any device that can receive data) about who should move left or right based on vote count. The host performs the action based on highest vote. Tokens are placed in a virtual escrow based on ability to vote and held by platform until host performs particular task. Upon successfully responding by performing the action, the host is paid a commission as set forth above.

A threshold-based voting session may include users rapidly clicking on votes or entering a bulk vote quantity. The higher votes during a given timeframe (5 seconds) the higher the threshold. The less votes during a given timeframe (5 seconds) the lower the threshold. Thresholds can be a bar chart (rising and falling), an odometer (rotating left to right) or the like. Thresholds may be gradual.

A timer-based voting session may include starting the timer with for a given length of time (i.e., 60 seconds). The timer may count down. Users may click on votes (one vote at a time) or enter a bulk vote quantity (i.e., 25 votes total, or the like). When the timer reaches zero seconds, the host performs the voted action. The host may have a given time (e.g., 10 seconds) to perform the action. After the given time, the voting timer resets. The time may oscillate.

Group consensus voting may be used for live stream, and may be used for on-site shows (at a physical location or virtually). For example, groups of users may vote on timed votes. In one example, the user has one minute to tell if the host is telling the truth or lying. Each user can vote either truth or lie. After time expires on the vote window, the host provides the actual answer—i.e., if it's a truth or lie. The team that was correct in their vote wins that challenge. The host signals whether the action was accurate or not to verify that challenge.

The present system and method also provides for bidirectional participation between users and host. Again, in an example, the users vote truth or lie, the host verifies, and whichever team voted correctly wins.

Groups may also vote on threshold votes. For example, team a and team b both vote. In an example where team a has higher number of votes, team a achieved more votes than team b during a specific time, therefore team a's action is performed. A threshold indicator may be increased based on move left for team a. The host views notification to move left during the duration of time. Then, for example, if team b increases vote count to move right, the host receives notification to move right based on vote count in real time.

Many other variations of the above are contemplated. For example, a host is shooting at a red or blue target (left or right) whichever is the longest, and the target used is based on the one that the teams have voted on more. The host has to keep up with vote count through an earpiece/screen or other feedback device.

In a method or flow of the present system, groups may vote during a running timer where audiences are watching a virtual show of a host painting on a canvas. The audiences/teams vote a particular color. The color receiving the highest number of votes determines the color for use on that portion of the canvas. Every 2 minutes the timer resets and teams are able to vote for the next color.

In a method or flow of the present system, groups may vote on threshold votes where team a and team b both try to get water balloon either left or right or center (votes can be 2 or more options). Team and team b, each vote left or right or center. Team a quoted higher than team b during a specific time. A threshold indicator is increased to move center (the selection for team a). Host views a notification to move selected center during the duration of time. Then, if team b increases vote count to move right, host receives notification to move right based on vote count in real time. The host is shooting at a red or blue or orange target (left or right or center), and the selected target is based on the highest threshold, the one teams have voted on more. The host has to keep up with vote count through an earpiece/screen or other feedback device.

Team votes may occur while on location with the event (on-site). When a participant, such as an audience member, is located generally at the same physical location of the event, team voting may be employed. Similar to the description above, user a (team a) and user b (team a) enters into application—ex. Website/mobile application and creates a log in or logs in. The user is notified to join a team (team a or team b). The user searches for browses existing live stream sessions. The user selects a live stream channel or live stream session in progress (game/show). The user is watching a live stream session in progress. The user then clicks on a button that says vote left or vote right (1 or more times). Each time user (a and b) vote, their team vote count increases. The team (team a) is competing with another team by placing conflicting votes. The users wait for the timer to count down. (timer can reset multiple times throughout the session-timer is customized to that particular show/action). The voting period may run based on a timer, a threshold, or both in order to cease recording votes. The live stream host receives a notification on website (laptop, mobile phone, Bluetooth, monitor, or any device that can receive data) providing instructions about who should move left or right based on vote count and it is displayed the host performs the action based on highest vote. The tokens are placed in a virtual escrow and held by platform until host performs particular task. Upon successfully responding, the host is paid a commission. After one or more actions, users (a and b) replenishes their vote tokens through payment flow.

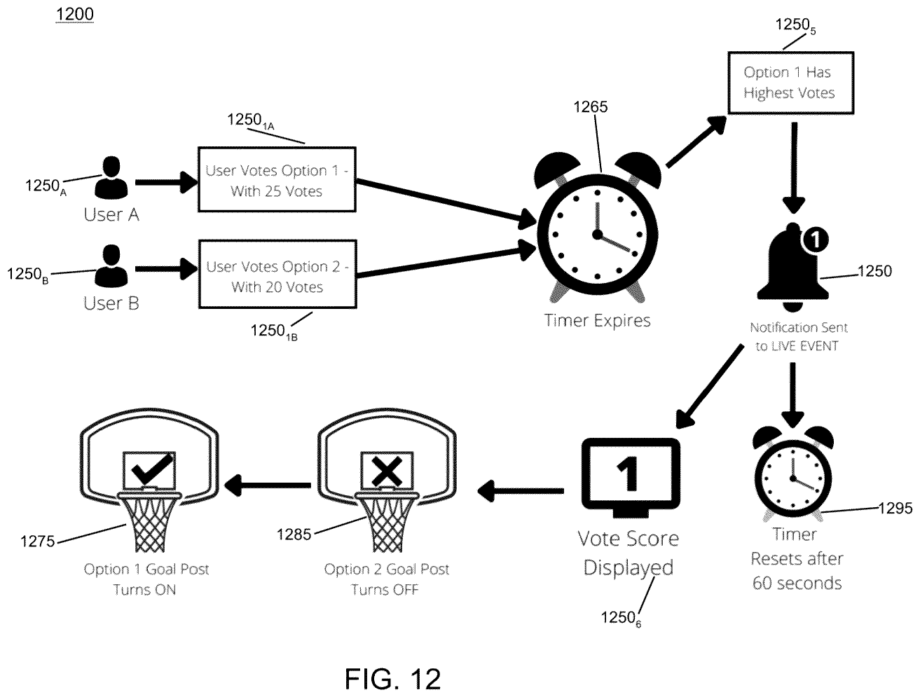

FIG. 12 illustrates a graphical depiction 1200 of a method or flow enabling team votes in a virtual example related to basketball games. A first entity A 1210_{A} (such as team A) and second entity B 1210_{B} (such as team B) are involved in a sporting event, i.e., a basketball game. When a user enters into application as discussed herein, the user is notified to join a team (team a or team b). The user searches for or browses existing live events and selects a live event in progress (not shown). The user watches the live event in progress. The user then selects a button that inputs a vote for option 1 1250_{1A}, i.e., move left, or a vote for option 2 1250_{1B}, i.e., move right. The votes may occur one or more times. The votes are tabulated as described allowing each entity 1210_{A}, 1210₈ to vote for their team multiple times to continue to increase the vote count. The votes may be counted until a timer expires 1265. After the timer expires 1265, the vote score is displayed 1250₆, notification is sent to the live event 1250 and an event is performed. The event may be activating a particular goal post for scoring such as option 1 1275 or option 2 1285 based on the vote. The timer may reset multiple times 1295 throughout the session. The timer may be customized to a particular event, for example.

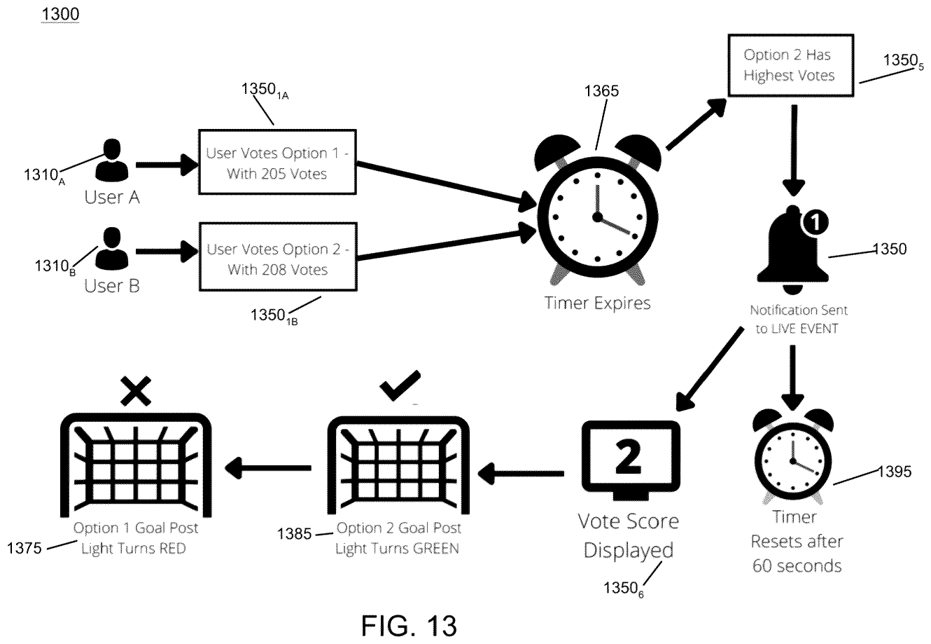

FIG. 13 illustrates a graphical depiction 1300 of a method or flow enabling team votes in a virtual example related to soccer games. A first entity A 1310_{A} (such as team A) and second entity B 1310_{B} (such as team B) are involved in a sporting event, i.e., a soccer game. When a user enters into application as discussed herein, the user is notified to join a team (team a or team b). The user searches for or browses existing live events and selects a live event in progress (not shown). The user watches the live event in progress. The user then selects a button that inputs a vote for option 1 1350_{1A}, i.e., move left, or a vote for option 2 1350_{1B}, i.e., move right. The votes may occur one or more times. The votes are tabulated as described allowing each entity 1310_{A}, 1310_{B} to vote for their team multiple times to continue to increase the vote count. The votes may be counted until a timer expires 1365. After the timer expires 1365, the vote score is displayed 1350₆, notification is sent to the live event 1350 and an event is performed. The event may be activating a particular goal post for scoring such as option 1 1375 or option 2 1385 based on the vote. The timer may reset multiple times 1395 throughout the session. The timer may be customized to a particular event, for example.

For example, in FIG. 13, the team has one minute to vote on soccer team (goalie—left or right). The user has one minute to vote on which goalie post will turn green. After that time, the goalie voted for most wins and players can only score on the post that is selected (green light).

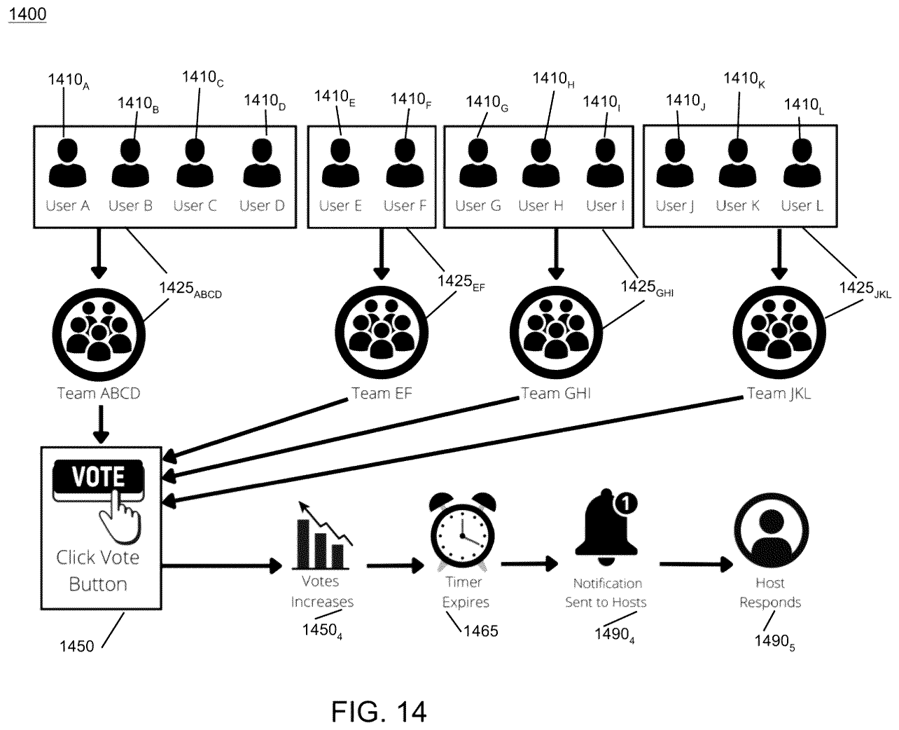

FIG. 14 illustrates a depiction 1400 of a method or flow in a system where groups of users vote, such as when users are in an audience watching a comedy show. For example, in FIG. 14, users 1410 may range from user A 1410_{A} through user L 1410_{L}. The users form teams and vote 1450 as a team, such as voting a particular skit the comedian should perform. In the example depiction 1400, user A 1410_{A}, user B 1410_{B}, user C 1410_{C}, user D 1410_{D} form team 1425_{ABCD}, user E 1410_{E}, user F 1410_{F} form team 1425_{EF}, user G 1410_{G}, user H 1410_{H}, user I 1410_{I} form team 1425_{GHI}, and user J 1410_{J}, user K 1410_{K}, user L 1410_{L} form team 1425_{JKL}. The votes are tabulated 1450₄ and after a timer expires 1465 notification is sent to the host 1490₄ (comedian) to perform 1490₅ the selected skit (skit 1 or skit 2 or skit 3) first. The skit that gets the highest number of laughs based on an audio level recorded provides a win to the team that selected that skit.

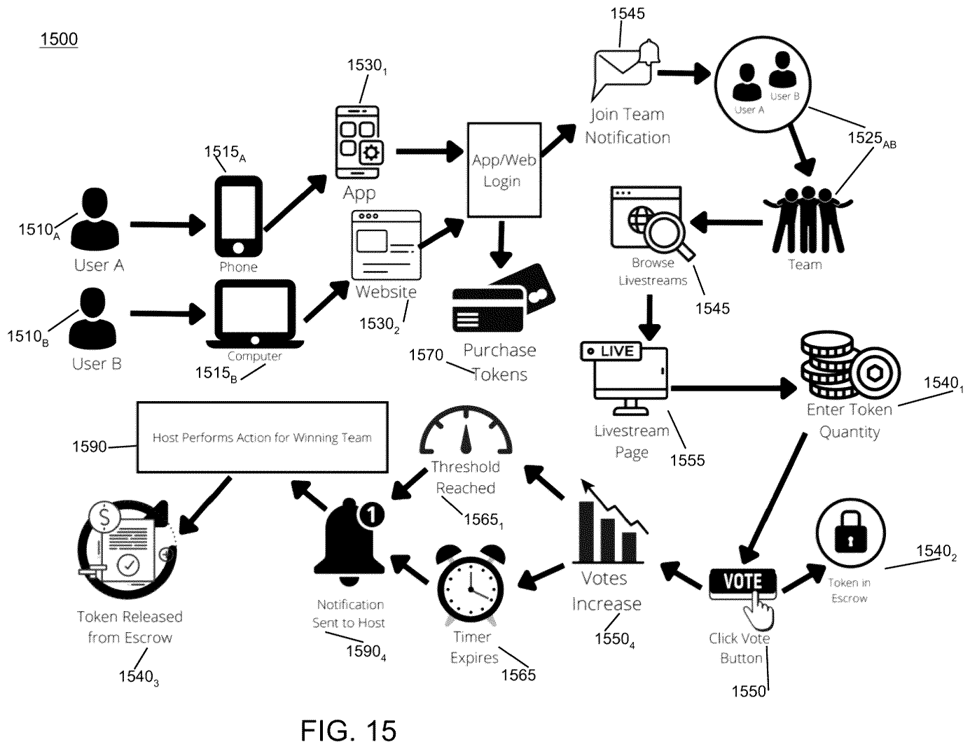

FIG. 15 illustrates a depiction 1500 of a method or flow of a system where groups of users vote on threshold votes. This may be useful when a DJ is performing a live session at a club, for example. An entity 1510_{A} uses an electronic device 1515_{A} to connect to the application 1530_{A}. An entity 1510_{B} uses an electronic device 1515_{b} to connect to the application 1530_{B}. Once both entities have joined the application, entity 1510_{A} and entity 1510_{B} may receive a join team notification 1545. They may each join a team 1525_{AB} Team 1525_{AB} votes on a live cast 1555 after selecting from a list of possible live events 1545. For example, the team may vote 1550 to determine the soundtrack the DJ should play next. Team 1525 voting on the song enter tokens 1545₁ to place vote. The votes are tallied 1550₄ until a timer expires 1565 or a threshold is reached 1565₁. A notification is sent to the host 1590₄ (DJ) when timer expires 1565 or threshold is reached 1565₁. The host performs 1590 the action that earned the most votes or the weighted voting based on tokens offered, Once performed the tokens offered are released 1540₃. In an example, the DJ may play the selected song for pre-defined length of time, while other teams increase their respective vote during set timeframe to switch songs or keep the song playing. Again, the host may receive notification to change songs based on vote count in real time. The host has to keep up with vote count through an earpiece/screen or other feedback device.

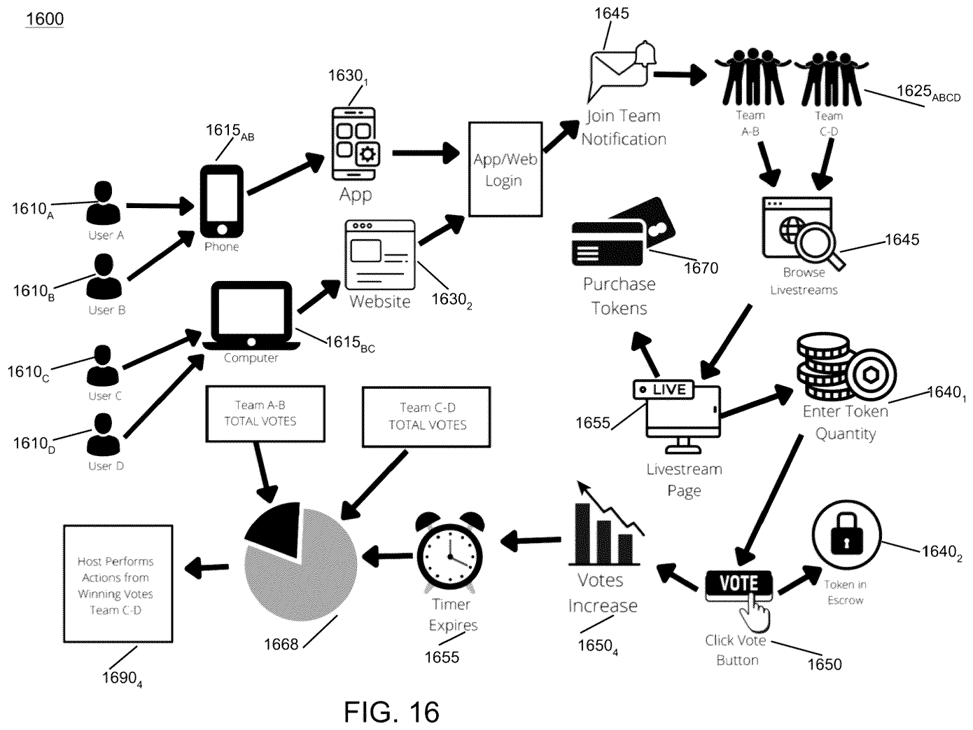

FIG. 16 illustrates a depiction 1600 of a method or flow of the system where groups vote on threshold votes. For example, a musician is singing a show. Teams must pick which song comes next. An entity 1610_{A} uses an electronic device 1615_{A} to connect to the application 1630_{A}. An entity 1610_{B} uses an electronic device 1615_{b} to connect to the application 1630_{B}. An entity 1610_{c}, uses an electronic device 1615_{c} to connect to the application 1630_{c}. An entity 1610_{D} uses an electronic device 1615_{D} to connect to the application 1630_{D}. Once both entities have joined the application, entity 1610_{A} and entity 1610_{B} may receive a join team notification 1645. They may each join a team 1625_{AB} or team 1625_{CD}. Team 1625_{AB}, team 1625_{CD} votes on a live cast 1655 after selecting from a list of possible live events 1645. For example, the team may vote 1650 to determine the song to sing. Team 1625 voting on the song enter tokens 1645₁ to place vote. The votes are tallied 1650₄ until a timer expires 1665 or a threshold is reached (not shown). A notification is sent to the host 1690₄ (DJ) when timer expires 1665 or threshold is reached. The host performs 1690 the action that earned the most votes or the weighted voting based on tokens offered. Once performed the tokens offered are released 1640₃. In an example, the musician may sing the selected song for pre-defined length of time based on feedback 1668, while other teams increase their respective vote during set timeframe to switch songs or keep the song playing. Again, the host may receive notification to change songs based on vote count in real time. The host has to keep up with vote count through an earpiece/screen or other feedback device.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random-access memory (RAM), a register, cache memory, semiconductor memory devices, magnetic media such as internal hard disks and removable disks, magneto-optical media, and optical media such as CD-ROM disks, and digital versatile disks (DVDs).

What is claimed is:

1. A method for a threshold-based voting session, the method comprising:
clicking on votes or entering a bulk vote quantity;
raising the threshold of votes needed when there are more votes during a given timeframe (5 seconds);
lowering the threshold where there are fewer votes during a given timeframe (5 seconds); and
ending the voting when a threshold number of votes is achieved.

2. A method for timer-based voting session, the method comprising:
starting a timer for a given length of time (i.e., 60 seconds);
voting (one vote at a time or enter a bulk vote quantity (i.e., 25 votes total, or the like));
at the expiry of the timer, performing the voted action within a time period;
resetting the voting timer.
